(19) United States
(12) Patent Application Publication
(10) Pub. No.: US 2025/0206408 A1
(43) Pub. Date: Jun. 26, 2025

(54) DRIVE DEVICE FOR AN ELECTRIC BICYCLE AND ELECTRIC BICYCLE

(71) Applicant: Porsche eBike Performance GmbH, Ottobrunn (DE)

(72) Inventor: Korbinian Lammel, Augsburg (DE)

(21) Appl. No.: 18/991,184

(22) Filed: Dec. 20, 2024

(30) Foreign Application Priority Data
Dec. 21, 2023 (DE) 10 2023 136 323.9

(51) Int. Cl. B62M 6/55; B62M 11/10; B62M 11/18

(52) U.S. Cl. CPC B62M 6/55; B62M 11/10; B62M 11/18

(57) ABSTRACT

A drive device for an electric bicycle has a gearbox with a first drive shaft, a second drive shaft and an output element. Torque of a first electric motor can be coupled into the gearbox via the first drive shaft. Torque of a second electric motor can be coupled into the gearbox via the second drive shaft. Torque can be removed from the gearbox via the output element. The first and second drive shafts run parallel to each other. One of the two drive shafts is guided through the other of the two drive shafts.

### CROSS-REFERENCE TO RELATED APPLICATIONS

This application claims priority of German patent application no. 10 2023 136 323.9, filed Dec. 21, 2023, the entire content of which is incorporated herein by reference.

### TECHNICAL FIELD

A drive device for an electric bicycle is specified. In addition, an electric bicycle is specified.

### BACKGROUND

Bicycles are a cost-effective, easy-to-use and emission-free means of transportation. They have also become popular as sports and fitness equipment, and particularly suitable types have emerged for different sporting uses.

In recent years, enthusiasm for electric bicycles (especially so-called “pedelecs”) has been growing, despite the high weight and price of bicycles. For electric bicycles, it is important to provide a reliable drive system that enables high power transmission.

### SUMMARY

It is an object of the disclosure to provide a drive device for an electric bicycle that contributes to an improved use of the available space.

The aforementioned object is achieved, inter alia, by a drive device for an electric bicycle. The drive device includes: a gearbox having a first drive shaft, a second drive shaft and an output element, wherein torque from a first electric motor is couplable into the gearbox via the first drive shaft and torque from a second electric motor is couplable into the gearbox via the second drive shaft; the output element being configured to dissipate torque from the gearbox; the first drive shaft and the second drive shafts run parallel to one another; and, one of the first drive shaft and the second drive shaft being guided through an other one of the first drive shaft and the second drive shaft.

It is a further object to provide an electric bicycle with such a drive device.

The aforementioned object is achieved, inter alia, by an electric bicycle including: a drive device for an electric bicycle, the drive device including a gearbox; the gearbox having a first drive shaft, a second drive shaft and an output element, wherein torque from a first electric motor is couplable into the gearbox via the first drive shaft and torque from a second electric motor is couplable into the gearbox via the second drive shaft; the output element being configured to dissipate torque from the gearbox; the first drive shaft and the second drive shaft run parallel to one another; one of the first drive shaft and the second drive shaft being guided through an other one of the first drive shaft and the second drive shaft; a down tube defining a main direction of extension; and, the first drive shaft and the second drive shaft extend parallel to the main direction of extension of the down tube.

First, the drive device for an electric bicycle is specified.

In at least one embodiment, the drive device for an electric bicycle has a gearbox with a first drive shaft, a second drive shaft and an output element. Torque from a first electric motor can be coupled into the gearbox via the first drive shaft. Torque from a second electric motor scan be coupled into the gearbox via the second drive shaft. Torque can be dissipated from the gearbox via the output element. The first and second drive shafts run parallel to each other. One drive shaft is guided through the other drive shaft.

The passage of one drive shaft through the other results in a particularly compact configuration. In particular, the drive device realizes a compact parallel superposition drive for an electric bicycle.

The gearbox includes, in particular, a plurality of gears engaging each other. For example, the gearbox converts a rotation of the first drive shaft into a rotation of the output element. Alternatively or in addition, the gearbox can convert a rotation of the second drive shaft into a rotation of the output element. In particular, the gearbox is configured to transmit torque from the first and/or second drive shaft to the output element. For example, the gearbox is configured so that the first and second drive shafts can rotate independently of each other. For example, the second drive shaft can also rotate independently of the output element.

The output element is, for example, a chainring or a chainring carrier or a chainring spider or a pulley.

The two drive shafts run parallel to each other. That is, the longitudinal axes of the drive shafts are parallel to each other.

The drive shafts are guided through or inserted into each other. Either the first drive shaft can be guided through the second drive shaft or the second drive shaft can be guided through the first drive shaft. In particular, one drive shaft is a hollow shaft through which the other drive shaft is guided. The first and second drive shafts are, in particular, coaxial with an axis. This axis forms, for example, an axis of rotation for both the first and the second drive shaft.

In at least one embodiment, the torques fed in via the two drive shafts are transmitted within the gearbox at least in sections on different sides of the drive shafts. “At least in sections” means that the path along which the respective torque is transmitted runs at least partially, that is, partially or completely, on one side of the output shafts.

In other words: If you look at the gearbox in a direction perpendicular to the longitudinal axes of the drive shafts, in particular also perpendicular to the axis of rotation of the output element and/or the axis of rotation/longitudinal axis of a pedal shaft of the drive device, with the longitudinal axes of the drive shafts are oriented vertically, that is, run from top to bottom, a torque fed in via the first drive shaft is transmitted at least in sections to the right of the longitudinal axes of the drive shafts and a torque fed in via the second drive shaft is transmitted at least in sections to the left of the longitudinal axes of the drive shafts. In order to realize the torque transfer on the different sides of the drive shafts, the gearbox includes at least one gear or at least one gear stage on one side of the drive shafts and at least one gear or at least one gear stage on the other side of the drive shafts. For example, at least one redirecting gear stage of the gearbox is arranged on one side and at least one further redirecting gear stage of the gearbox is arranged on the other side of the drive shafts.

This two-sided or symmetrical torque guidance results in improved utilization of space and thus a more compact configuration.

In one embodiment, the gearbox is configured such that torque fed in from the first drive shaft is directly diverted from the first drive shaft to one side of the drive shafts and torque fed in from the second drive shaft is directly diverted from the second drive shaft to the opposite side of the drive shafts. In particular, the torques are diverted away from the drive shafts in opposite directions.

According to at least one embodiment, the drive device further includes a first electric motor that is coupled, in particular directly coupled, to the first drive shaft. When the first electric motor is operated, the first drive shaft is set in rotation by the first electric motor.

The drive device is configured, for example, such that the first electric motor can only rotate in a direction that corresponds to the propulsion of the electric bicycle. In this rotational direction, the first electric motor can, for example, be operated in a motoric and regenerative manner.

According to at least one embodiment, the drive device further includes a second electric motor that is coupled to the second drive shaft, in particular directly coupled. When the second electric motor is operated, the second drive shaft is set in rotation by the second electric motor.

The drive device is configured in particular such that rotation of the second electric motor is possible in both rotational direction (in the event that the brake introduced below is open). The second electric motor can, for example, be operated in a motoric manner in only one of the two rotational directions. In this one rotational direction, operation of the second electric motor in a regenerative manner is then preferably also possible. In the other rotational direction, the second electric motor can then only be operated in a regenerative manner. Alternatively, however, it is also possible for the second electric motor to be operated in both rotational directions in a motoric and regenerative manner.

Two elements can be coupled directly or indirectly. “Coupled” here means in particular that the rotation of one element leads to the rotation of the other. In this context, a direct coupling means in particular that there is no transmission or change in the rotational direction between the elements. In this context, an indirect coupling means in particular that there is a transmission and/or change in the rotational direction between the elements. Indirectly coupled elements are coupled to each other via a gear stage, for example. Directly coupled elements can be connected to each other in a rotationally fixed manner.

The first electric motor, for example, forms a main motor. The second electric motor then forms, for example, an auxiliary motor. The main motor has a greater maximum power, in particular a greater maximum torque, than the auxiliary motor. For example, the maximum power or maximum torque of the main motor is at least 1.5 times or at least twice as great or at least 3 times as great as that of the auxiliary motor.

According to at least one embodiment, the two electric motors are arranged one behind the other in the direction of the longitudinal axes of the first and second drive shafts. For example, the first electric motor is arranged in the direction of the longitudinal axes between the gearbox and the second electric motor, or the second electric motor is arranged in this direction between the gearbox and the first electric motor.

According to at least one embodiment, the gearbox is configured to transfer torque from an electric motor coupled to the first drive shaft to the output element in order to drive the bicycle with motor assistance. In other words, the gearbox is configured so that the torque acting on the first drive shaft is transmitted to the output element with a specific transmission ratio, enabling the electric bicycle to be driven by the motor.

For example, a speed ratio between the first drive shaft and the output element is between 1:1 and 1:10 or between 1:10 and 1:4, typically about 1:2.

According to at least one embodiment, the gearbox has a pedal shaft, also known as a pedal crank shaft. The pedal shaft runs, for example, transversely or perpendicularly to the drive shafts or their longitudinal axes. The axis of rotation of the output element also runs, for example, transversely or perpendicularly to the longitudinal axes of the drive shafts. In particular, the axis of rotation of the output element and the axis of rotation of the pedal shaft are parallel or congruent. The drive device is, for example, an orthogonal drive.

According to at least one embodiment, the gearbox is configured to transmit torque from the pedal shaft to the output element in order to drive the electric bicycle via a pedaling movement. This means that the electric bicycle can be propelled by driving the pedal shaft with a pedaling motion. In particular, the pedal shaft is coupled to the output element via one or more gear stages of the gearbox for this purpose. The pedal shaft can be coupled to a first of these gear stages via a freewheel or can be connected in a rotationally fixed manner to a gear wheel of this first gear stage.

According to at least one embodiment, the drive device is a parallel hybrid drive. “Hybrid” means that the electric bicycle is driven by the drive device either by muscle power or by an assisting electric motor (in this case the first electric motor) or by both together. When both act together, that is, pedaling motion and assistive electric motor, a torque resulting from the electric motor and a torque resulting from the pedaling motion are added at a point of combination. The speed resulting from the electric motor at the point of combination and the speed resulting from the pedaling motion at the point of combination are equal. The point of combination is, for example, the output element or an element of the gearbox that is connected to it in a rotationally fixed manner. The term “parallel” results from this torque addition.

In contrast, in a serial hybrid drive, the assisting electric motor is activated by the cyclist, that is, by the pedaling motion, and superimposes its own speed so that the output then turns faster (or slower) than the cyclist pedals.

In at least one embodiment, the longitudinal axes of the drive shafts cross or pass the pedal shaft substantially at or near the center of the pedal shaft. For example, the point of intersection or closest approach is at a distance between 0.4 and 0.6 times, or between 0.45 and 0.55 times the length of the pedal shaft from one longitudinal end of the pedal shaft.

If the longitudinal axes of the drive shafts do not cross the pedal shaft but run past it at an oblique angle, the bevel gear stages introduced below can, for example, be configured as hypoid bevel gear stages.

According to at least one embodiment, the gearbox is configured such that a transmission ratio of the torque transmission or the speed transmission from the pedal shaft to the output element can be adjusted by rotating the second drive shaft, for example via an electric motor. In particular, the second drive shaft can be used to achieve a stepless gear change, that is, a stepless change in the transmission ratio. The second drive shaft is therefore not, or not primarily, used to transmit torque from the second drive shaft to the output element, but rather to adjust the transmission ratio of the gearbox for the transmission of torque from the pedal shaft to the output element.

According to at least one embodiment, the gearbox is configured such that rotation of the second drive shaft in one rotational direction increases the transmission ratio and rotation in the opposite rotational direction decreases the transmission ratio. In particular, the gearbox is configured so that, in principle, rotation in both opposite directions of the second drive shaft is possible (for example, when a brake introduced below is released).

The stationary transmission of the gearbox, that is, when the second drive shaft is stationary (not rotating), is predetermined by the configuration of the gearbox. In the present case, this stationary transmission does not preferably form the lowest gear, that is, the smallest possible transmission ratio. Rather, the gear or the transmission ratio can be increased and decreased (steplessly) from the stationary transmission, namely by rotating the second drive shaft in one or the other rotational direction. The maximum transmission ratio or the highest gear of the gearbox and the lowest transmission ratio or the lowest gear of the gearbox depends on the maximum speed at which the second drive shaft can rotate in one direction and the other rotational direction. This is determined, for example, by the electric motor coupled to the second drive shaft.

For example, the (maximum) speed of rotation in one direction can be set by motoric operation of the electric motor. In the other rotational direction, the resistance of the electric motor to rotation and thus the (maximum) speed of rotation can be set, for example, by a respective counter-voltage. Alternatively or additionally, this could also be achieved by frequency control, pulse width modulation or other control techniques. Alternatively, the (maximum) rotational speed in the other rotational direction can also be specified by motoric operation of the electric motor.

The smallest possible transmission ratio (for example, for driving uphill) and the largest possible transmission ratio (for example, for driving fast) define a speed spread (Δn) of the drive device. For example, the stationary transmission is in the lower half, especially in the lower third, of this speed spread. For example, the stationary transmission is between n1+¼·Δn and n1+⅖·Δn or exactly n1+⅓·Δn. Here, n1 is the predetermined lowest transmission ratio of the drive device, n2 is the predetermined highest transmission ratio of the drive device, and Δn=n2−n1 is the speed spread.

According to at least one embodiment, the gearbox for adjusting the transmission ratio via rotation of the second drive shaft has a differential in the form of a bevel gear differential gearbox or a planetary gearbox or a stepped planetary gearbox or a crown gear differential gearbox. For this purpose, the differential is coupled in particular to the first and second drive shafts, the pedal shaft and the output element.

According to at least one embodiment, the differential is a planetary gearbox. In this case, for example, the second drive shaft is coupled to a ring gear of the planetary gearbox, for example indirectly. The pedal shaft is coupled to a sun gear of the planetary gearbox, for example, in particular connected in a rotationally fixed manner or coupled via a freewheel thereto. The output element is coupled to a planet carrier of the planetary gearbox, in particular connected in a rotationally fixed manner. The first drive shaft can be coupled to the planet carrier, in particular indirectly coupled.

The axes of rotation of the sun gear, the ring gear, the planet carrier and the planet gears, for example, all run parallel to the axis of rotation of the output element or the pedal shaft.

In at least one embodiment, the differential is a stepped planetary gearbox. In this case, for example, one sun gear of the stepped planetary gearbox is coupled to the second drive shaft, another sun gear of the stepped planetary gearbox is coupled to the output element, and the planet carrier of the stepped planetary gearbox is coupled to the pedal shaft. The planet carrier can be connected to the pedal shaft in a rotationally fixed manner or coupled via a freewheel thereto.

According to at least one embodiment, the differential is a bevel gear differential gearbox. An epicyclic gear carrier of the bevel gear differential gearbox is then coupled, for example, to the pedal shaft, in particular connected in a rotationally fixed manner or coupled to it via a freewheel. At least one epicyclic bevel gear is arranged on the epicyclic gear carrier. The output element is coupled, for example, to a first main bevel gear of the bevel gear differential gearbox, in particular in a rotationally fixed manner, the first main bevel gear being in engagement with the at least one epicyclic bevel gear. The second drive shaft can be coupled to a second main bevel gear of the bevel gear differential gearbox, in particular indirectly coupled, wherein the second main bevel gear is in engagement with the at least one epicyclic bevel gear. For example, the first drive shaft is coupled to the first main bevel gear, in particular indirectly coupled.

One, two or more epicyclic bevel gears can be arranged on the epicyclic gear carrier, each of which is in engagement with the first and second main bevel gear. The epicyclic bevel gears of a bevel gear differential gearbox can also be referred to as planet gears. The epicyclic gear carrier can also be referred to as an epicyclic gear cage or differential cage.

The axes of rotation of the two main bevel gears and the epicyclic gear carrier are parallel to the axis of rotation of the output element or pedal shaft. The axis of rotation of the at least one epicyclic bevel gear is perpendicular to the axis of rotation of the output element or pedal shaft.

According to at least one embodiment, the first and second main bevel gears are arranged on different sides of the drive shafts. In other words, when viewed in a direction perpendicular to the longitudinal axes of the drive shafts, with the longitudinal axes oriented vertically, one main bevel gear is located on the left and one main bevel gear is located on the right of the drive shafts. This allows a space-saving and compact configuration.

According to at least one embodiment, the gearbox has a bevel gear stage that is coupled on the one hand to the first drive shaft and on the other hand to the output element. This bevel gear stage is also referred to below as the first bevel gear stage. A bevel gear of the first bevel gear stage is coupled to the output element for torque transmission in at least one rotational direction, without changing the speed or rotational velocity. This means that the coupling is such that torque can be transmitted from the bevel gear to the output element in at least one rotational direction, with the bevel gear and the output element rotating at the same speed. The axes of rotation of the bevel gear and the output element are parallel or coincident. In particular, the bevel gear of the first bevel gear stage and the output element are coupled to each other without an intermediate gear stage. A gear stage is understood to be a pair of intermeshing gears. For example, the bevel gear of the first bevel gear stage is (only) coupled to the output element via a freewheel or is connected to the output element in a rotationally fixed manner.

The other bevel gear of the first bevel gear stage can be connected to the first drive shaft in a rotationally fixed manner. Alternatively, a spur gear stage, hereinafter also referred to as the first spur gear stage, can be provided between the first drive shaft and the first bevel gear stage, via which the first drive shaft is then coupled to the first bevel gear stage. For example, at most one gear stage is connected between the first bevel gear stage and the first drive shaft.

According to at least one embodiment, the gearbox has a further bevel gear stage. This further bevel gear stage is also referred to below as the second bevel gear stage. The second bevel gear stage is coupled to the second drive shaft. For example, the second drive shaft is then connected in a rotationally fixed manner to a bevel gear of the second bevel gear stage. Alternatively, a spur gear stage can be connected between the second drive shaft and the second bevel gear stage, via which the second drive shaft is coupled to the second bevel gear stage. This spur gear stage is also referred to below as the second spur gear stage. For example, at most one gear stage is connected between the second bevel gear stage and the second drive shaft.

In the case of the differential being a planetary gearbox, the first drive shaft can be coupled to the planet carrier via the first bevel gear stage. In particular, a bevel gear of the first bevel gear stage can be coupled to the planet carrier in a rotationally fixed manner. The second drive shaft is, for example, coupled to the ring gear of the planetary gearbox via the second bevel gear stage. In particular, the ring gear can be connected to a bevel gear of the second bevel gear stage in a rotationally fixed manner or can form this bevel gear.

In the case of a differential being a bevel gear differential gearbox, the first drive shaft is coupled to the first main bevel gear via the first bevel gear stage, for example. The first main bevel gear can be connected to a bevel gear of the first bevel gear stage in a rotationally fixed manner or can form this bevel gear. The second drive shaft is coupled to the second main bevel gear via the second bevel gear stage, for example. The second main bevel gear can be connected to a bevel gear of the second bevel gear stage in a rotationally fixed manner or can form this bevel gear.

According to at least one embodiment, the bevel gear stage and the further bevel gear stage are arranged on different sides of the drive shafts. In other words, when viewed in a direction perpendicular to the longitudinal axes of the drive shafts, with the longitudinal axes oriented vertically, the bevel gear stage is located to the left of the drive shafts and the further bevel gear stage is located to the right of the drive shafts. Respectively, the first and second spur gear stages can be arranged on different sides of the drive shafts.

According to at least one embodiment, the differential is a crown gear differential gearbox. An epicyclic gear carrier of the crown gear differential gearbox is then coupled, for example, to the pedal shaft, in particular connected in a rotationally fixed manner or coupled to it via a freewheel. At least one epicyclic spur gear is arranged on the epicyclic gear carrier. The output element is coupled, in particular connected in a rotationally fixed manner, to a first main crown gear of the crown gear differential gearbox, for example, the first main crown gear being in engagement with the at least one epicyclic spur gear. The second drive shaft can be coupled to a second main crown gear of the crown gear differential gearbox, in particular indirectly coupled, with the second main crown gear being in engagement with the at least one epicyclic spur gear. For example, the first drive shaft is coupled to the first main crown gear, in particular indirectly coupled.

One, two or more epicyclic spur gears can be arranged on the epicyclic gear carrier, each of which is in engagement with the first and second main crown gear.

The axes of rotation of the two main crown gears and of the epicyclic gear carrier run in particular parallel to the axis of rotation of the output element or of the pedal shaft. The axis of rotation of the at least one epicyclic spur gear is in particular transversely or perpendicularly to the axis of rotation of the output element or the pedal shaft.

According to at least one embodiment, the first and second main crown gears are arranged on different sides of the drive shafts. In other words, when viewed perpendicular to the longitudinal axes of the drive shafts, with the longitudinal axes oriented vertically, one main crown gear is located to the left and one main crown gear is located to the right of the drive shafts. This allows a space-saving and compact configuration.

According to at least one embodiment, the drive device includes a brake. The brake is assigned to the second drive shaft. In particular, the brake is coupled to the second drive shaft. The brake is configured to counteract rotation of the second drive shaft in at least one rotational direction, for example to lock or block this rotation.

The brake can be applied directly to the second drive shaft or to an electric motor coupled to the second drive shaft. The brake can be configured to counteract rotation of the second drive shaft in only one rotational direction or in both rotational directions. In this context, “rotation” refers, of course, to rotation around the longitudinal axis of the second drive shaft.

The brake can be configured to completely block or lock rotation in at least one rotational direction. Alternatively or additionally, the brake can be configured so that the braking force applied by it is adjustable. Depending on the set braking force, the brake can therefore impede the rotation of the second drive shaft to a greater or lesser extent in at least one rotational direction, optionally up to and including complete blocking. A complete blockage can be achieved, for example, by a form-fitting engagement. An impediment to rotation, up to and including complete blockage, that is, adjustment of the braking force, can be achieved, for example, by frictional engagement.

The brake can be controlled mechanically and/or electrically. For example, the braking effect of the brake can be adjusted via electrical control signals. However, it is also possible for the braking effect of the brake to be adjusted manually by the operator of the electric bicycle. For example, the brake of the drive device can be or can be coupled to the rear and/or front wheel brake of the electric bicycle, so that when the front or rear wheel brake is applied, the brake for the second drive shaft is also applied and then counteracts a rotation of the second drive shaft in the at least one rotational direction.

According to at least one embodiment, the brake is configured to apply a supporting torque against a rotation of the second drive shaft when the electric bicycle is started from a standstill, in particular when the stationary transmission is set, in order to enable a stiff start. In particular, the brake is configured such that it opposes a respective supporting torque to a torque transmitted from the pedal shaft to the second drive shaft when accelerating. In this way, it can be avoided that work applied for manual advancement is lost in rotation of the second drive shaft or in rotation of the (second) electric motor connected to it. In particular, the brake blocks rotation of the second drive shaft in both directions of rotation when starting pedaling from a standstill.

In at least one embodiment, the brake is a mechanical brake. For example, the brake includes brake blocks for clamping a brake disc. The brake disc is non-rotatably attached, for example, to the rotor of the second electric motor or to the second drive shaft itself. Alternatively, the brake may also include one or more pins that engage with recesses when the brake is applied to completely block rotation of the second drive shaft. For example, the brake includes a freewheel for blocking rotation of the second drive shaft in only one rotational direction.

According to at least one embodiment, the brake is configured to frictionally generate a braking effect for both rotational directions of the second drive shaft. That is, the brake, when applied, frictionally counteracts rotation of the second drive shaft in both rotational directions.

According to at least one embodiment, the brake is configured to brake an existing rotation of the second drive shaft. For example, the brake is configured to brake or counteract rotation of the second drive shaft that sets a lower gear than in the stationary transmission. Alternatively or additionally, the brake can be configured to brake or counteract rotation of the second drive shaft that sets a higher gear than in the stationary transmission.

According to at least one embodiment, the braking force with which rotation of the second drive shaft is counteracted is adjustable with the brake. In particular, the frictional force with which the brake achieves its braking effect can be increased or decreased.

Furthermore, it is also possible that the brake is an electromagnetic brake, for example a magnetic brake or an eddy current brake.

Next, the electric bicycle is specified. In particular, the electric bicycle is a pedelec.

In at least one embodiment, the electric bicycle includes a drive device according to one of the embodiments described herein. Furthermore, the electric bicycle includes a down tube. The two drive shafts extend essentially parallel to the main direction of extension of the down tube. For example, the drive shafts are arranged within the down tube. The first and second electric motors can also be arranged in the down tube. In particular, the down tube extends perpendicularly to the pedal shaft.

Since the electric bicycle has a drive device as described herein, all features disclosed in connection with the drive device are also disclosed for the electric bicycle and vice versa.

### BRIEF DESCRIPTION OF DRAWINGS

The invention will now be described with reference to the drawings wherein:

FIG. 1 shows an embodiment of an electric bicycle; and,

FIGS. 2 to 7 show various embodiments of a drive device.

### DETAILED DESCRIPTION

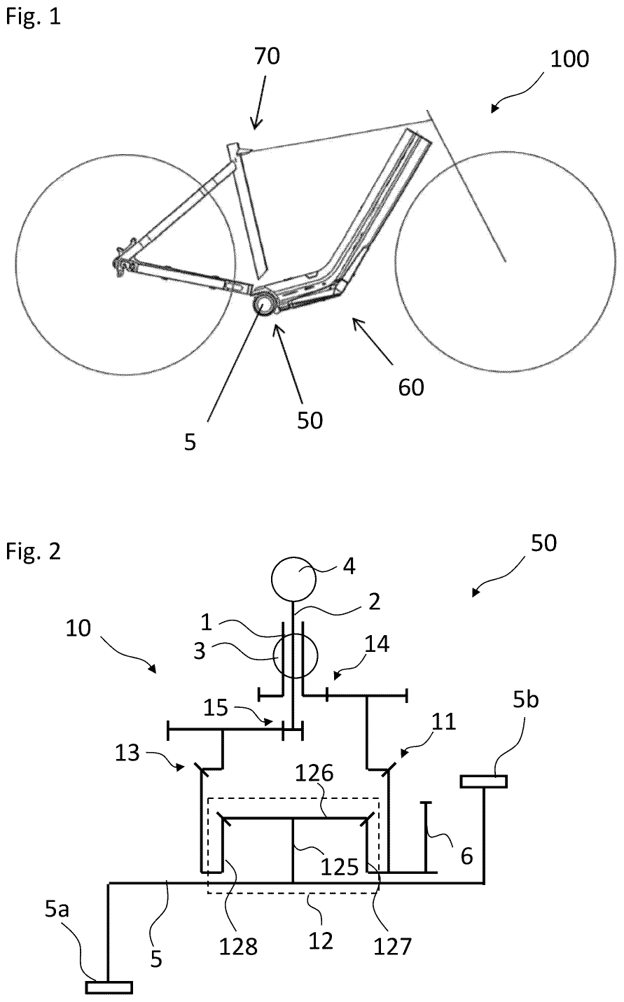

FIG. 1 schematically shows an electric bicycle 100 with a bicycle frame 70, which includes, among other things, a lower frame section 60 that forms a down tube. The frame section 60 extends in the direction of a bottom bracket that includes a pedal shaft 5. The pedal shaft 5 is part of a drive device 50 for the electric bicycle 100.

The following FIGS. 2 to 6 show embodiments of this drive device 50. Bearings for relative rotation between the adjacent elements are shown as black rectangles.

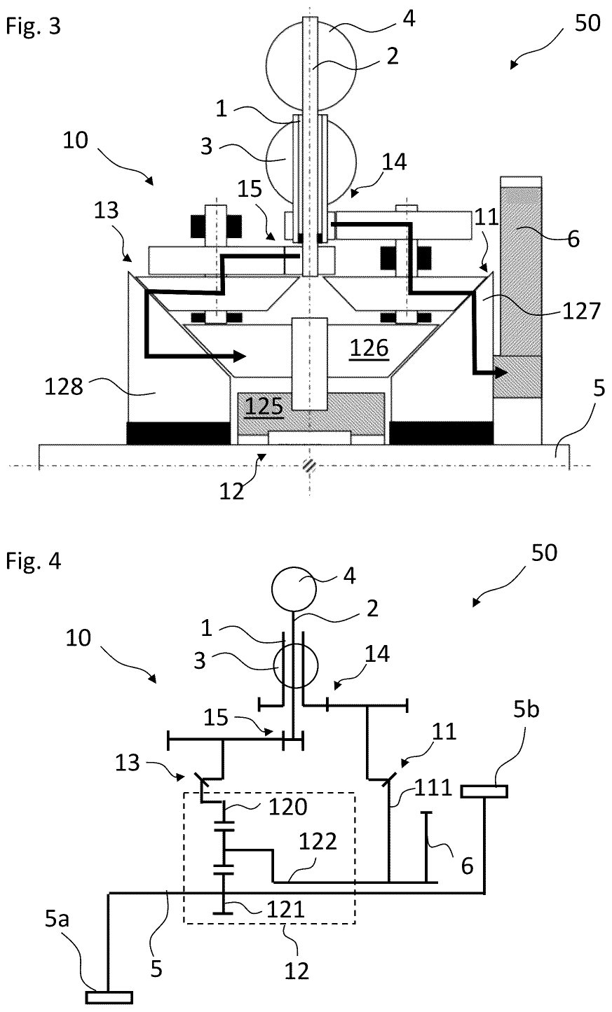

FIGS. 2 and 3 show an embodiment of the drive device 50 in two different illustrations. The drive device 50 includes a gearbox 10 with two drive shafts 1, 2 and an output element 6. Torque is coupled into the gearbox 10 via the drive shafts 1, 2. Torque can be removed from the gearbox 10 via the output element 6.

In the present case, the first drive shaft 1 is a hollow shaft and the second drive shaft 2 is guided or inserted through the hollow shaft 1 and arranged coaxially with it. In particular, the longitudinal axes or axes of rotation of the two drive shafts 1, 2 coincide.

The drive shafts 1, 2 are each coupled to an electric motor 3, 4. For example, the drive shafts 1, 2 of the drive device 50 of FIGS. 2 and 3 extend within the down tube 60 along the main direction of extension of the down tube 60 in the fully assembled electric bicycle 100. The two electric motors 3, 4 can then be arranged in the down tube 60.

The first electric motor 3 is configured as the main electric motor for motor-assisted driving of the electric bicycle. The second electric motor 4 is an auxiliary electric motor that is provided for a continuously adjustable transmission ratio for manual driving of the electric bicycle. In particular, the second electric motor 3 has a lower power than the first electric motor 4.

The drive device 50 of FIGS. 2 and 3 additionally includes the pedal shaft 5, which is connected on the left and right to a pedal crank or pedal 5a, 5b, respectively (shown only in FIG. 2). Via the pedals 5a, 5b, the pedal shaft 5 can be set in rotation by a pedaling movement. The pedal shaft 5 extends perpendicularly to the drive shafts 1, 2. The extension of the drive shafts 1, 2 or their longitudinal axes intersect the pedal shaft 5 in the center in FIGS. 2 and 3 or do not intersect the pedal shaft 5, but run past it in the center in a skewed manner.

The gearbox 10 of the drive device 50 of FIGS. 2 and 3 further includes a differential 12 in the form of a bevel gear differential gearbox. The bevel gear differential gearbox 12 has two main bevel gears 127, 128 whose axes of rotation are parallel to the pedal shaft 5 or are congruent with it. The main bevel gears 127, 128 engage with epicyclic bevel gears 126. The epicyclic bevel gears 126 are in turn arranged rotatably on an epicyclic gear carrier 125, which is connected to the pedal shaft 5 in a rotationally fixed manner.

The first main bevel gear 127 is connected in a rotationally fixed manner to the output element 6. The output element 6 is, for example, a chainring or a chainring carrier or a chainring spider or a pulley. The first main bevel gear 127 is part of a first bevel gear stage 11. The first bevel gear stage 11 is coupled to the first drive shaft 1 via a first spur gear stage 14.

The second main bevel gear 128 is part of a second bevel gear stage 13, which is coupled to the second drive shaft 2 via a second spur gear stage 15.

The pedal shaft 5 is set in rotation by operating the pedals 5a, 5b. This rotation is transmitted to the epicyclic gear carrier 125. Consequently, the epicyclic bevel gears 126 also move around the axis of rotation of the pedal shaft 5. However, since these are in meshed engagement with the main bevel gears 127, 128, the movement of the epicyclic bevel gears 126 can be related to a rotation of the epicyclic bevel gears 126 around axes of rotation perpendicular to the pedal shaft 5. The engagement with the main bevel gears 127, 128, in turn, may cause the main bevel gears 127, 128 to rotate as well. This then results, for example, in a rotation of the output element 6. In this way, the electric bicycle can be propelled manually, that is, by pedaling.

Whether and to what extent the first main bevel gear 127 and thus the output element 6 are driven by the pedaling movement also depends on the second drive shaft 2 that can be driven by the second electric motor 4. Rotation of the second drive shaft 2 results in a superimposed rotation of the second main bevel gear 128. This changes the transmission ratio from the pedal shaft 5 to the output element 6. Depending on how fast and in which direction the second drive shaft 2 rotates, the transmission ratio becomes higher or lower. The rotational speed of the second drive shaft 2 can be predetermined, in particular, with the help of the coupled electric motor.

The drive device 50 of FIGS. 2 and 3 also enables additional motor-assisted propulsion of the electric bicycle 100. Via the first spur gear stage 14 and the first bevel gear stage 11, torque can be transmitted from the first electric motor 3 to the output element 6, thus supporting the propulsion of the electric bicycle via a motor.

In FIG. 3, black arrows indicate the torque paths along which the torques are directed from the drive shafts 1, 2 in the gearbox 10. In particular, due to the arrangement of elements of the gearbox 10, such as the gear stages 11, 13, 14 and 15, on both sides, to the left and right of the drive shafts 1, 2, the torques coupled in via the drive shafts 1, 2 are transmitted at least in sections on different sides of the drive shafts 1, 2. The torque is derived directly from the drive shafts 1, 2 in opposite directions.

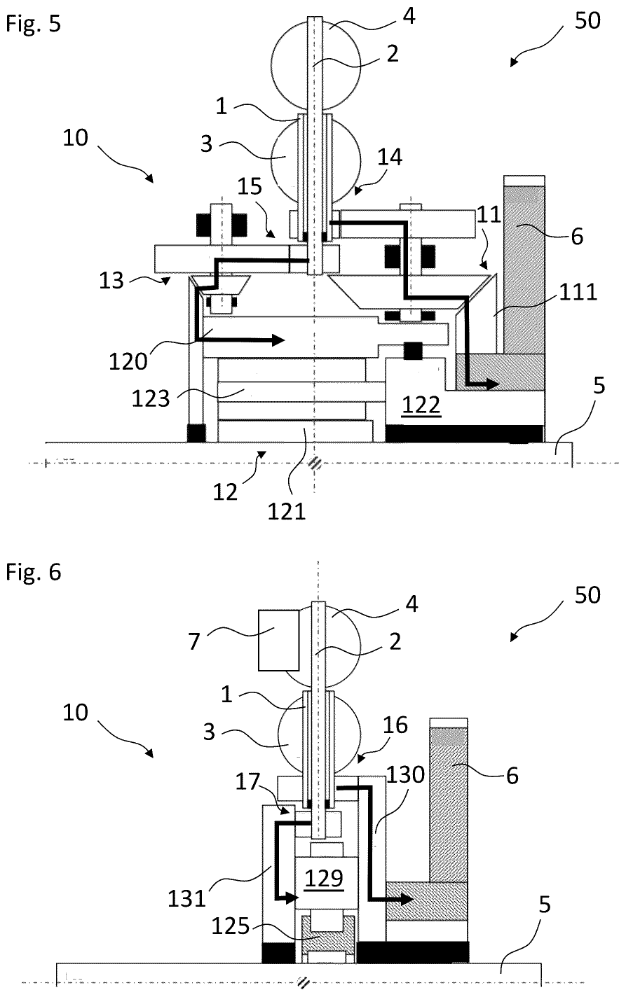

FIGS. 4 and 5 show another embodiment of the drive device 50 again in two different illustrations.

The difference to the embodiment of FIGS. 2 and 3 is that a planetary gearbox is used here as differential 12 instead of a bevel gear differential gearbox. The pedal shaft 5 is connected to the sun gear 121 of the planetary gearbox 12 in a rotationally fixed manner. The ring gear 120 of the planetary gearbox 12 is coupled to the second drive shaft 2 via the second bevel gear stage 13 and the second spur gear stage 15. The planet carrier 122, on which the planet wheels 123 are rotatably mounted, is coupled to the output element 6 in a rotationally fixed manner. The planet gears 123, in turn, are coupled to the ring gear 120 and the sun gear 121 via a toothed engagement.

When the pedals 5a, 5b are activated, the pedal shaft 5 starts to rotate. This is transferred to the sun gear 121, which also rotates around the axis of rotation of the pedal shaft 5, respectively. The meshing of the sun gear 121 with the planet gears 123 causes the latter to rotate if necessary. This in turn can cause the planet carrier 122 to rotate, which in turn causes the output element 6 to rotate.

The rotation of the ring gear 120 can be adjusted via the coupling to the second drive shaft 2 by the electric motor 4 connected to it. Depending on how fast and in which direction the ring gear 120 is rotated, the transmission ratio from the pedal shaft 5 to the planet carrier 122 and thus to the output element 6 changes.

As in FIGS. 2 and 3, an additional motor-assisted drive of the electric bicycle by coupling the first drive shaft 1 to the output element 6 via the first spur gear stage 14 and the first bevel gear stage 11 is enabled also in FIGS. 4 and 5. The bevel gear 111 of the first bevel gear stage 11 is connected to the output element 6 in a rotationally fixed manner.

The torque paths are again shown in FIG. 5. Once again, torque is transmitted on different sides of the drive shafts 1, 2.

FIG. 6 shows a further embodiment of the drive device 50, in which a crown gear differential gearbox with a first 130 and a second 131 main crown gear is used as the differential 12. Both are in meshed engagement with at least one epicyclic spur gear 129. The epicyclic spur gear 129 is rotatably mounted on an epicyclic gear carrier 125. The epicyclic gear carrier 125 is connected to the pedal shaft 5 in a rotationally fixed manner. The first main crown gear 130 is connected to the output element 6 in a rotationally fixed manner and forms a crown gear of a first crown gear transmission stage 16, which is coupled to the first drive shaft 1. The second main crown gear 131 forms part of a second crown gear transmission stage 17, which is coupled to the second drive shaft 2. The operating principle of the stepless transmission ratio adjustment between the pedal shaft 5 and the output element 6, as well as the motor assistance provided by the first electric motor 3, is the same as in the previous embodiments.

In the embodiment of FIG. 6, the spur gear stages 14, 15 used in FIGS. 2 to 5 are dispensed with. These could also be omitted in FIGS. 2 to 5. In particular, due to the omission of the spur gear stages, an axis of rotation of the epicyclic spur gear 129 is offset in the direction of the longitudinal axis of the pedal shaft 5 to the longitudinal axes of the drive shafts 1, 2. FIG. 6 also shows the torque paths.

In FIG. 6, the drive device 50 additionally includes a brake 7 coupled to the second drive shaft 2. The brake 7 serves to counteract rotation of the second drive shaft 2 in one or both directions of rotation. To do this, the brake 7 can either completely block a rotation (for example, by form fit or frictional engagement) or only impede it (for example, by frictional engagement) when it is actuated. The brake is configured, for example, as a mechanical brake. The brake 7 acts on the second electric motor 4. The brake 7 can be actuated manually and/or electrically. For example, for electrical operation, the brake 7 is signally connected to a control unit (not shown) of the electric bicycle to receive respective control signals. When the bicycle is stationary and the stationary transmission is set, the brake can be activated/set, for example, so that a torque applied by the driver when starting up is not wasted in the rotation of the second drive shaft. For example, a “stiff” start is possible and a pleasant driving experience is achieved.

Although a brake 7 is shown only with the drive device 50 of FIG. 6, such a brake can also be used with the drive devices 50 of FIGS. 2 to 5.

In all embodiments, the guiding of the drive shafts 1, 2 through each other results in a particularly compact configuration of the drive device 50. This effect is enhanced by the torque transmission on both sides to the left and right of the longitudinal axes of the drive shafts 1, 2, as is the case in all embodiments.

In the previous embodiments, the pedal shaft 5 was always connected in a rotationally fixed manner to a component of the differential 12. Alternatively, however, the pedal shaft 5 could also be coupled to the component via a freewheel in each case. Furthermore, in the previous embodiments, the output element 6 was connected in a rotationally fixed manner to a bevel gear 111, 127 or crown gear 130 of the first bevel gear stage 11 or the crown gear stage 16. However, a coupling between the bevel gear 111, 127 or crown gear 130 and the output element 6 via a freewheel could also be used instead.

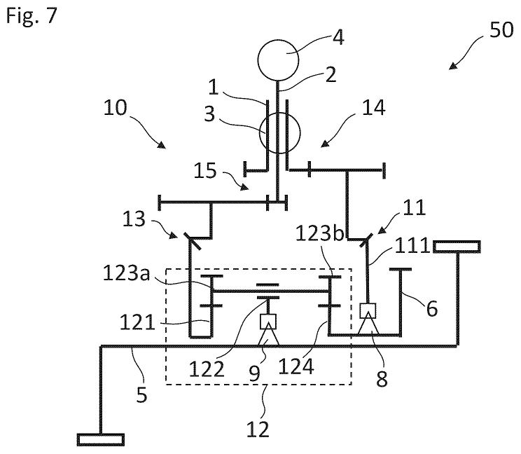

In the embodiment of FIG. 7, the differential 12 is a stepped planetary gearbox with two sun gears 121, 124 and a planet carrier 122. Planet gears 123a, 123b are rotatably mounted on the planet carrier 122 and are in engagement with either the first 121 or the second 124 sun gear. In particular, the planet gears 123a, 123b are connected to one another in a rotationally fixed manner.

The first sun gear 121 is coupled to the second drive shaft 2 via the second bevel gear stage 13 and the second spur gear stage 15. The second sun gear 124 is connected to the output element 6 in a rotationally fixed manner. The planet carrier 122 is coupled to the pedal shaft 5 via a freewheel 9. Alternatively, there could also be a rotationally fixed connection between the pedal shaft 5 and the planet carrier 122.

Furthermore, a freewheel 8 is provided between the output element 6 and the bevel gear 111 of the first bevel gear stage 11 so that, when rotating in one rotational direction, torque can be transmitted from the bevel gear 111 to the output element 6 and the bevel gear 111 and the output element 6 rotate at the same speed. This prevents the electric motor 4 from being “dragged”, which results in less resistance when pedaling in operating conditions without motor assistance by the electric motor 4.

It is understood that the foregoing description is that of the preferred embodiments of the invention and that various changes and modifications may be made thereto without departing from the spirit and scope of the invention as defined in the appended claims.

### LIST OF REFERENCES

1 first drive shaft
2 second drive shaft
3 first electric motor
4 second electric motor
5 pedal shaft
6 output element
7 brake
8 freewheel
9 freewheel
10 gearbox
11 first bevel gear stage
12 differential
13 second bevel gear stage
14 first spur gear stage
15 second spur gear stage
16 first crown gear stage
17 second crown gear stage
50 drive device
60 down tube
70 bicycle frame
100 electric bicycle
111 bevel gear
120 ring gear
121 sun gear
122 planet carrier
123 planet gear
123a planet gear
123b planet gear
124 sun gear
125 epicyclic gear carrier
126 epicyclic bevel gear
127 first main bevel gear
128 second main bevel gear
129 epicyclic spur gear
130 first main crown gear
131 second main crown gear

1. A drive device for an electric bicycle, the drive device comprising:
a gearbox having a first drive shaft, a second drive shaft and an output element, wherein torque from a first electric motor is couplable into said gearbox via said first drive shaft and torque from a second electric motor is couplable into said gearbox via said second drive shaft;
said output element being configured to dissipate torque from said gearbox;
said first drive shaft and said second drive shafts run parallel to one another; and,
one of said first drive shaft and said second drive shaft being guided through an other one of said first drive shaft and said second drive shaft.

2. The drive device of claim 1, wherein:
said gearbox has a bevel gear stage that is coupled to said first drive shaft and to said output element; and,
a bevel gear of said bevel gear stage is coupled to said output element for transmitting torque in at least one rotational direction without a change in rotational speed.

3. The drive device of claim 1, wherein the torques fed in via said first drive shaft and said second drive shaft are transmitted within said gearbox at least in sections on different sides of said first drive shaft and said second drive shaft.

4. The drive device of claim 1 further comprising:
said first electric motor coupled to said first drive shaft;
said second electric motor coupled to said second drive shaft;
said first drive shaft and said second drive shaft each defining a longitudinal axis; and,
said first electric motor and said second electric motor being arranged one behind an other in a direction of said longitudinal axes of said first drive shaft and said second drive shaft.

5. The drive device of claim 1, wherein said gearbox is configured for torque transmission from an electric motor coupled to said first drive shaft to said output element in order to drive the electric bicycle with motor assistance.

6. The drive device of claim 1, wherein:
said gearbox has a pedal shaft that extends transversely or perpendicularly to said first drive shaft and said second drive shaft; and,
said gearbox is configured to transmit torque from said pedal shaft to said output element to drive the electric bicycle via a pedaling movement.

7. The drive device of claim 6, wherein said first drive shaft and said second drive shaft each define a longitudinal axis; said longitudinal axes of said first drive shaft and said second drive shaft cross or pass the pedal shaft in or at a center of said pedal shaft.

8. The drive device of claim 6, wherein said gearbox is configured such that a transmission ratio of a torque transmission from said pedal shaft to said output element is configured to be set by rotating said second drive shaft.

9. The drive device of claim 8, wherein for setting the transmission ratio, said gearbox has a differential in a form of a bevel gear differential gearbox or a planetary gearbox or a stepped planetary gearbox or a crown gear differential gearbox.

10. The drive device of claim 9, wherein:
said differential is a planetary gearbox;
said second drive shaft is coupled to a ring gear of said planetary gearbox;
said pedal shaft is connected to a sun gear of said planetary gearbox in a rotationally fixed manner; and,
said output element is connected to a planet carrier of said planetary gearbox in a rotationally fixed manner.

11. The drive device of claim 9, wherein:
said differential is a stepped planetary gearbox;
said second drive shaft is coupled to a sun gear of said stepped planetary gearbox;
said pedal shaft is coupled to a planet carrier of said stepped planetary gearbox; and,
said output element is coupled to a further sun gear of said stepped planetary gearbox.

12. The drive device of claim 9, wherein:
said differential is a bevel gear differential gearbox;
an epicyclic gear carrier of said bevel gear differential gearbox is connected to said pedal shaft in a rotationally fixed manner;
at least one epicyclic bevel gear is arranged on said epicyclic gear carrier;
said output element is coupled in a rotationally fixed manner to a first main bevel gear of said bevel gear differential gearbox, said first main bevel gear being in engagement with said at least one epicyclic bevel gear; and,
said second drive shaft is coupled to a second main bevel gear of said bevel gear differential gearbox, said second main bevel gear being in engagement with said at least one epicyclic bevel gear.

13. The drive device of claim 12, wherein said first main bevel gear and said second main bevel gear are arranged on different sides of said first drive shaft and said second drive shaft.

14. The drive device of claim 2, wherein:
said gearbox has a further bevel gear stage which is coupled to said second drive shaft; and,
said bevel gear stage and said further bevel gear stage are arranged on different sides of said first drive shaft and said second drive shaft.

15. The drive device of claim 9, wherein:
said differential is a crown gear differential gearbox;
an epicyclic gear carrier of said crown gear differential gearbox is connected to said pedal shaft in a rotationally fixed manner;
at least one epicyclic spur gear is arranged on said epicyclic gear carrier;
said output element is coupled in a rotationally fixed manner to a first main crown gear of said crown gear differential gearbox, said first main crown gear being in engagement with said at least one epicyclic spur gear; and,
said second drive shaft is coupled to a second main crown gear of said crown gear differential gearbox, said second main crown gear being in engagement with said at least one epicyclic spur gear.

16. An electric bicycle comprising:
a drive device for an electric bicycle, the drive device including a gearbox;
said gearbox having a first drive shaft, a second drive shaft and an output element, wherein torque from a first electric motor is couplable into said gearbox via said first drive shaft and torque from a second electric motor is couplable into said gearbox via said second drive shaft;
said output element being configured to dissipate torque from said gearbox;
said first drive shaft and said second drive shaft run parallel to one another;
one of said first drive shaft and said second drive shaft being guided through an other one of said first drive shaft and said second drive shaft;
a down tube defining a main direction of extension; and,
said first drive shaft and said second drive shaft extend parallel to said main direction of extension of the down tube.

17. A drive device for an electric bicycle, the drive device comprising:
a gearbox with a first drive shaft, a second drive shaft and an output element, wherein torque from a first electric motor is couplable into said gearbox via said first drive shaft and torque from a second electric motor is couplable into said gearbox via said second drive shaft;
said output element being configured to dissipate torque from said gearbox;
said first drive shaft and said second drive shaft run parallel to one another;
one drive shaft of said first drive shaft and said second drive shaft being guided through an other one of said first drive shaft and said second drive shaft;
said gearbox having a bevel gear stage coupled to said first drive shaft and to the output element; and,
a bevel gear of said bevel gear stage being coupled to said output element for transmitting torque in at least one rotational direction without a change in rotational speed.
